(19) United States
(12) Patent Application Publication
(10) Pub. No.: US 2014/0286051 A1
(43) Pub. Date: Sep. 25, 2014

(54) DISPLAY DEVICE

(71) Applicant: KABUSHIKI KAISHA TOKAI RIKA DENKI SEISAKUSHO, Aichi (JP)

(72) Inventors: Satoshi OKURA, Aichi (JP); Yoshiyuki AOKI, Aichi (JP)

(73) Assignee: KABUSHIKI KAISHA TOKAI RIKA DENKI SEISAKUSHO, Aichi (JP)

(21) Appl. No.: 14/218,259

(22) Filed: Mar. 18, 2014

(30) Foreign Application Priority Data
Mar. 21, 2013 (JP) 2013-058675

(51) Int. Cl. F21V 8/00

(52) U.S. Cl. CPC G02B 6/0031
USPC 362/609

(57) ABSTRACT

A display device includes a light source part to output a light, a light incidence part into which the light outputted from the light source part is inputted, a groove part formed in a first surface of the light incidence part based on a display pattern to be displayed via the light incidence part, a background part formed on the first surface of the light incidence part except the groove part and configured to form a background of the display pattern, and a reflection part formed on the groove part to reflect a part of the light that enters the light incidence part so as to form the display pattern on the background formed by a part of the light reflected by the background part. The inputted light is outputted outside through a second surface opposite to the first surface of the light incidence part.

The present application is based on Japanese patent application No. 2013-058675 filed on Mar. 21, 2013, the entire contents of which are incorporated herein by reference.

### BACKGROUND OF THE INVENTION

1. Field of the Invention

This invention relates to a display device.

2. Description of the Related Art

As a conventional technique, a display device is known, the display comprising a substrate having translucency, a warning color printed layer disposed in the rear surface of the substrate, a dark color semitransparent layer formed on the front surface corresponding to the warning color printed layer, a black printed layer disposed around the dark color semitransparent layer and configured to reduce the quantity of the light that reflects toward the inside of the substrate, and a warning display slit disposed in the dark color semitransparent layer corresponding to a warning display desired for displaying it (for example, JP-A-H09-138661).

The display device is configured such that a light output from a warning display electric light bulb disposed below the warning color printed layer is output toward the outside via the warning color printed layer, the substrate, the dark color semitransparent layer and the warning display slit so that the warning display can be visually recognized in the warning color.

### SUMMARY OF THE INVENTION

The conventional display device is configured such that the warning display electric light bulb is disposed below the warning color printed layer for the purpose of illuminating the warning display brightly, thus it has been difficult for the display device to allow the warning display to have an excellent design with a depth feeling and a three dimensional feeling.

It is an object of the invention to provide a display device ₜhat can display an excellent design with a depth feeling or a three dimensional feeling.

(1) According to one embodiment of the invention, a display device comprises:

a light source part configured to output a light;

a light incidence part into which the light outputted from the light source part is inputted;

a groove part formed in a first surface of the light incidence part based on a display pattern to be displayed via the light incidence part;

a background part formed on the first surface of the light incidence part except the groove part and configured to form a background of the display pattern; and

a reflection part formed on the groove part and configured to reflect a part of the light that enters the light incidence part so as to form the display pattern on the background formed by a part of the light reflected by the background part,

wherein the inputted light is outputted outside through a second surface opposite to the first surface of the light incidence part.

### Effects of the Invention

According to one embodiment of the invention, a display device can be provided that can display an excellent design with a depth feeling or a three dimensional feeling.

### BRIEF DESCRIPTION OF THE DRAWINGS

The preferred embodiments according to the invention will be explained below referring to the drawings, wherein:

FIG. 1A is an exploded perspective view schematically showing a display device according to an embodiment of the invention;

FIG. 1B is a top view schematically showing the display device according to the embodiment of the invention;

FIG. 2A is a bottom view schematically showing a laminated body of the display device according to the embodiment of the invention when viewed from the substrate side;

FIG. 2B is a cross-sectional view schematically showing a section cut along the line II(b)-II(b) in FIG. 1B when viewed from the direction of the arrow mark;

FIG. 2C is an enlarged cross-sectional view schematically showing a periphery of a region in which the display pattern is formed;

FIGS. 3A to 3C are cross-sectional views schematically showing the primary portion of a manufacturing process of the display device according to the embodiment of the invention; and

FIGS. 4A to 4C are cross-sectional views schematically showing the primary portion of Modifications 1 to 3 according to the embodiment of the invention.

### DETAILED DESCRIPTION OF THE PREFERRED EMBODIMENTS

### Summary of the Embodiments

The display device according to the embodiment includes a light source part configured to output a light, a light incidence part that the light output from the light source part enters, a groove part formed in a first surface of the light incidence part based on a display pattern displayed via the light incidence part, a background part formed in the first surface of the light incidence part so as to avoid the groove part, and configured to form a background of the display pattern, and a reflection part formed in the groove part, and configured to reflect a part of the light that enters the light incidence part so as to form the display pattern on the background formed by a part of the light reflected by the background part.

This display device is configured such that the background is indirectly illuminated, and simultaneously the display pattern is formed based on the light reflected by the reflection part formed three-dimensionally, thus the display device makes it possible to illuminate the display pattern stronger than the background, and to allow a display to have an excellent design with a depth feeling and a three dimensional feeling, although an indirect illumination.

### Embodiments

### Configuration of the Display Device 1

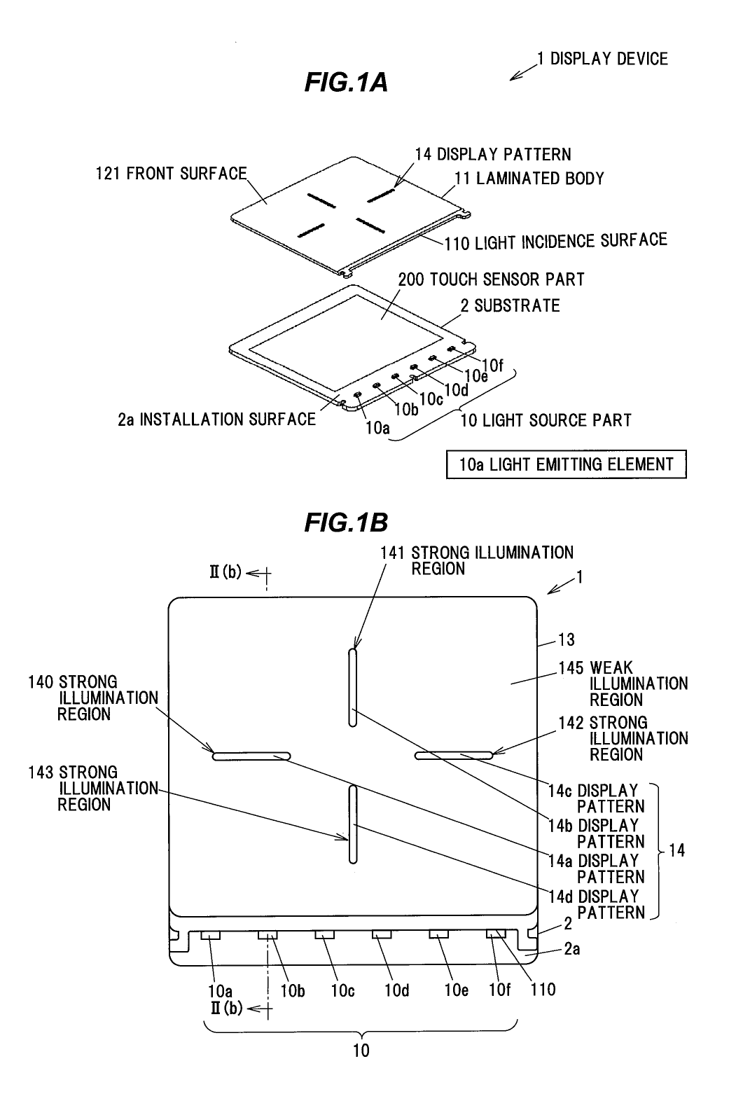

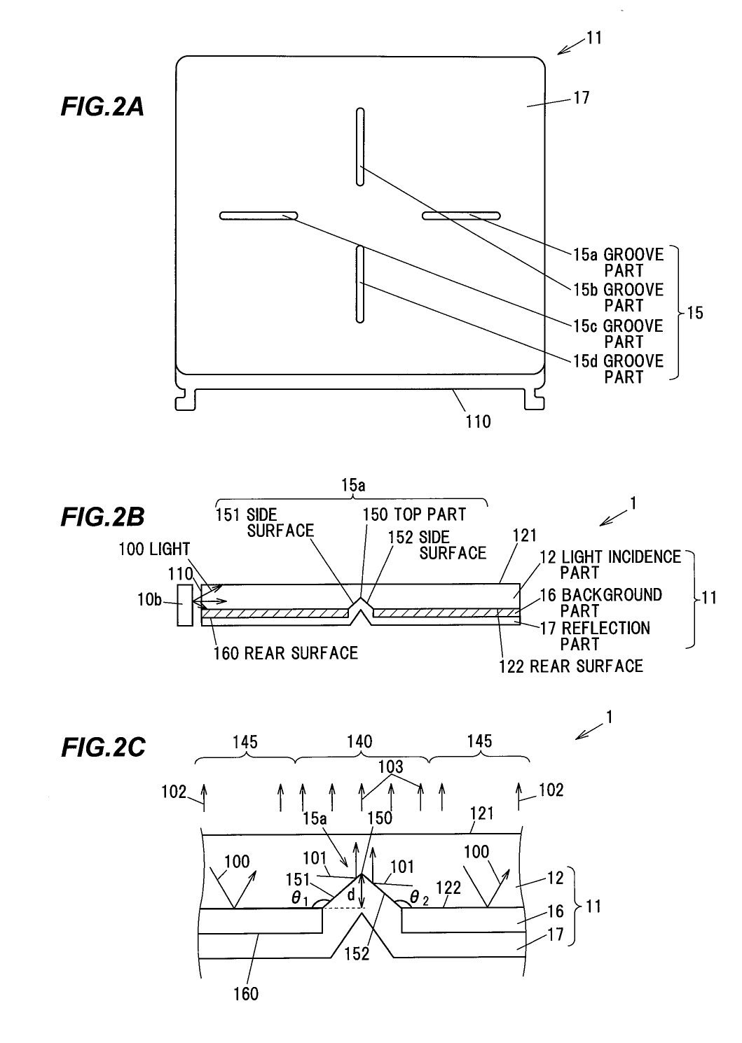

FIG. 1A is an exploded perspective view schematically showing the display device according to the embodiment of the invention, and FIG. 1B is a top view schematically showing the display device according to the embodiment of the invention. FIG. 2A is a bottom view schematically showing the laminated body of the display device according to the embodiment of the invention when viewed from the substrate side, FIG. 2B is a cross-sectional view schematically showing a section cut along the line II(b)-II(b) in FIG. 1B when viewed from the direction of the arrow mark, and FIG. 2C is an enlarged cross-sectional view schematically showing a periphery of a region in which the display pattern is formed. Further, in the respective drawings according to the embodiment, the ratio between the figures can be different from the actual ratio.

The display device 1 constitutes, as one example, a part of an operation device mounted in vehicles. The operation device is configured to, as one example, be able to operate a cursor and the like displayed on a monitor mounted in vehicles. The display device 1 is installed in, as one example, a part corresponding to the operation part of the operation device, but not limited to this.

As shown in FIGS. 1A to 1C and FIGS. 2A, 2B, the display device 1 is roughly configured to mainly include the light source part 10 configured to output a light, the light incidence part 12 that the light output from the light source part 10 enters, the groove part 15 formed in the rear surface 122 as the first surface of the light incidence part 12 based on the display pattern 14 displayed via the light incidence part 12, the background part 16 formed in the rear surface 122 of the light incidence part 12 so as to avoid the groove part 15, and configured to form a background of the display pattern 14, and the reflection part 17 formed in the groove part 15, and configured to reflect a part of the light that enters the light incidence part 12 so as to form the display pattern 14 on the background formed by a part of the light reflected by the background part 16.

Hereinafter, a component integrated with the light incidence part 12, the background part 16 and the reflection part 17 will be referred to as the laminated body 11. The front surface of the laminated body 11 is the front surface 121 of the light incidence part 12, and the substrate 2 is formed on a surface of an opposite side to the front surface 121.

### Configuration of the Substrate 2

The substrate 2 is, for example, a printed wiring board formed in a rectangular shape. As shown in FIG. 1A, in the installation surface 2a of the substrate 2, the touch sensor part 200 having a rectangular shape is formed. The touch sensor part 200 is configured, for example, to include an electrostatic capacitance type touch sensor. The touch sensor part 200 is configured to detect an operation carried out to the front surface 121 of the light incidence part 12. In the substrate 2, the light source part 10 is arranged parallel to one side of the touch sensor part 200.

### Configuration of the Light Source Part 10

The light source part 10 is roughly configured, as one example, to include the light emitting elements 10a to 10f. The light emitting elements 10a to 10f is, as one example, Light Emitting Diode (LED). Further, the type and the number of the light emitting element are not limited to the above, but can be changed in accordance with the application thereof.

The light source part 10 is configured to output a light from the light incidence surface 110 that is a side surface of the light incidence part 12 to the inside of the light incidence part 12. In particular, the light emitting elements 10a to 10f of the light source part 10 are arranged side by side along one side of the touch sensor part 200 at a predetermined interval. The light emitting elements 10a to 10f of the light source part 10 are arranged such that the optical axis thereof is substantially orthogonal to the normal line of the installation surface 2a, and the light can be output toward the light incidence surface 110 that is a side surface of the laminated body 11 in the longitudinal direction.

The light emitting elements 10a to 10f are configured to output a light corresponding to a color of the display pattern 14 displayed in the display device 1. In the embodiment, as one example, the display pattern 14 is configured to emit a light of a white based color, thus the light emitting elements 10a to 10f are comprised of a light emitting diode that outputs a light of a white based color.

### Configuration of the Light Incidence Part 12

The light incidence part 12 transmits the light output from the light source part 10.

Namely, the light incidence part 12 is configured to propagate the light to the inside thereof. Accordingly, the light incidence part 12 is comprised of, as one example, a resin that has a high transmittance to the outside (approximately 90%) such as a Metylmethacrylate Butadiene Styrene copolymer (MBS) resin, a transparent Acrylonitrile Butadiene Styrene copolymer (ABS) resin, a Styrene Block Copolymer (SBC) resin, a PolyCarbonate (PC) resin and a PolyEthylene Terephathalate (PET) resin.

The light incidence part 12 is, for example, a transparent plate-like member. The light incidence part 12 according to the embodiment is comprised of, as one example, a polycarbonate resin. The light incidence part 12 has a thickness of, as one example, 1 mm. Further, as a modification of the light incidence part 12, for example, a configuration that includes a material which allows the incident light to be diffused can be also adopted.

In addition, the light incidence part 12 is configured such that, for example, in order to allow fingers to slide more easily, surface embossing or texturing is applied to the front surface 121. Since the light incidence part 12 is configured such that the surface embossing is applied to the front surface 121, the light can be easily reflected toward the direction of the background part 16 as compared with a case where the surface embossing is not applied. Furthermore, the light incidence part 12 is configured such that, as one example, an UltraViolet (UV) hard coat having antistatic property, UV absorbing property and the like is applied thereto.

### Configuration of the Display Pattern 14

As shown in FIG. 1B, the display pattern 14 is roughly configured to include, for example, the display patterns 14a to 14d. The display patterns 14a to 14d have a long narrow linear shape having a predetermined width of which corners are rounded.

The display pattern 14a is mainly formed by a light reflected by the reflection part 17 of the groove part 15a mentioned later that is formed below the strong illumination region 140 shown on the left side of the sheet of FIG. 1B. The display pattern 14b is formed in a position where the display pattern 14a is rotated clockwise by 90 degrees on the sheet of FIG. 1B.

The display pattern 14b is mainly formed by a light reflected by the reflection part 17 of the groove part 15b mentioned later that is formed below the strong illumination region 141 shown on the upper side of the sheet of FIG. 1B. The display pattern 14c is formed in a position where the display pattern 14b is rotated clockwise by 90 degrees.

The display pattern 14c is mainly formed by a light reflected by the reflection part 17 of the groove part 15c mentioned later that is formed below the strong illumination region 142 shown on the right side of the sheet of FIG. 1B. The display pattern 14d is formed in a position where the display pattern 14c is rotated clockwise by 90 degrees.

The display pattern 14d is mainly formed by a light reflected by the reflection part 17 of the groove part 15d mentioned later that is formed below the strong illumination region 143 shown on the lower side of the sheet of FIG. 1B. The display pattern 14a is formed in a position where the display pattern 14d is rotated clockwise by 90 degrees. Namely, the display pattern 14 in the embodiment is configured such that, as one example, four long narrow lines are arranged in a cross-like pattern so as not to intersect with each other.

The display pattern 14 displayed via the light incidence part 12 has, for example, a white based color. The display pattern 14 is configured such that it can be visually recognized via the light incidence part 12 even if the illumination by the light source part 10 is not carried out.

The weak illumination region 145 around the strong illumination regions 140 to 143 is a background of the display pattern 14, and is a region illuminated weakly than the strong illumination regions 140 to 143. The weak illumination region 145 has a color to which the color of the background part 16 is mainly reflected

In particular, the weak illumination region 145 is a region where a part of the light reflected by the background part 16 outputs from the light incidence part 12, thereby weak illumination is carried out. In addition, the strong illumination regions 140 to 143 are regions where a part of the light reflected by the reflection part 17 of the groove part 15 projecting toward the light incidence part 12 outputs from the light incidence part 12, thereby stronger illumination than the weak illumination region 145 is carried out.

### Configuration of the Groove Part 15

As shown in FIGS. 2A to 2C, the groove part 15 is formed below the respective display patterns 14a to 14d. The groove part 15 has a shape obtained when a part of the light incidence part 12 is cut out. The groove part 15 is formed by, for example, a method using a laser, a cutting, a mold and the like. In the embodiment, the groove part 15 is simultaneously formed when the light incidence part 12 is formed by an injection molding.

The groove part 15 of the embodiment is roughly configured to include the groove parts 15a to 15d corresponding to the display patterns 14a to 14d. The groove parts 15a to 15d are formed in the substantially same shape except for the direction in which those are formed. Consequently, hereinafter, the groove part 15a will be mainly explained instead of the explanation of the groove parts 15a to 15d. In addition, the groove parts 15a to 15d have the substantially same shape, thus common references are used for the bottom 150, the side surface 151, and the side surface 152.

As shown in FIG. 2C, it is preferable that the distance d from the rear surface 122 of the light incidence part 12 to the bottom 150 of the groove part 15 falls within the range of, as one example, not less than 20% and not more than 40% of the thickness of the light incidence part 12. If the distance d is not more than 10%, light quantity to be reflected is reduced, thus there is a possibility that the display pattern 14 is not illuminated more strongly than the background, and if not less than 50%, it becomes difficult for the light to reach a region farther from the light source part 10, thus there is a possibility that illumination unevenness is caused.

As shown in FIGS. 2B, 2C, the groove part 15 of the embodiment has a tapered shape (for example, V-shape). Taking the groove part 15a for example, as shown in FIG. 2C, an angle θ₁ formed between the side surface 151 of the groove part 15a and the rear surface 122 of the light incidence part 12 and an angle θ₂ formed between the side surface 152 and the rear surface 122 are configured to be substantially equal to each other. In addition, similarly to the groove part 15a, the groove parts 15b to 15d are configured such that the angle θ₁ and the angle θ₂ are substantially equal to each other. Further, the groove part 15 is not limited to having the tapered shape, but if it has a shape that is capable of reflecting the light propagating through the light incidence part 12 in an upward direction, the shape can be changed in accordance with the forming method and the like.

### Configuration of the Background Part 16

The background part 16 is formed, for example, on the rear surface 122 of the light incidence part 12 by printing. However, the background part 16 is formed so as not to fill the groove part 15. The printing is carried out, for example, by using a printing method such as a screen printing method, an inkjet printing method. In addition, an ink used for the printing is selected in accordance with the above-mentioned printing method, the color of the background and the like. The background part 16 has a thickness of, as one example, 8 μm.

The background part 16 is formed by using, for example, a black based ink that does not transmit the light (as an example of a light-absorbing material). Consequently, the weak illumination region 145 looks such that, for example, the background of black color is indirectly illustrated. Namely, the light 100 that propagates through the inside of the light incidence part 12 while reflecting is configured such that a part thereof is reflected as the light 102 on the rear surface 122 that becomes a substantial interface between the light incidence part 12 and the background part 16, so as to be output from the weak illumination region 145.

### Configuration of the Reflection Part 17

The reflection part 17 is formed on the rear surface 160 of the background part 16 after the groove part 15 is formed. The reflection part 17 is formed, for example, by using a printing method such as a screen printing method, an inkjet printing method. In addition, an ink used for the printing is selected in accordance with the above-mentioned printing method, the color of the display pattern 14 and the like. The reflection part 17 has a thickness of, as one example, 20 μm.

As shown in FIGS. 2B, 2C, the reflection part 17 is also formed in the inside of the groove part 15. The reflection part 17 is configured such that a part thereof is formed in the inside of the light incidence part 12. Consequently, the light that propagates through the inside of the light incidence part 12 while reflecting is reflected by the side surface 151 or the side surface 152 of the groove part 15 projecting toward the light incidence part 12, and a part thereof is output from the strong illumination region corresponding to the groove part 15. Further, the reflection part 17 can be formed in only the groove part 15.

As shown in FIG. 2C, in the groove part 15a, for example, the light 100 that propagates through the inside of the light incidence part 12 while reflecting becomes the light 101 reflected by the side surface 151 or the side surface 152, and a part thereof is output from the strong illumination region 140 as the light 103. The groove part 15 is formed in the inside of the light incidence part 12, thus a larger quantity of the light 100 can be reflected upward in comparison with the light reflected by the rear surface 122 of the light incidence part 12. Therefore, the groove part 15 is capable of forming the strong illumination regions 140 to 143, namely, the display pattern 14 on the front surface 121 in a state that the light flux per unit area, namely “brightness” is heightened.

Hereinafter, an illumination of the display device 1 according to the embodiment will be explained.

### Illumination of the Display Device 1

As shown in FIG. 2B, the display device 1 is configured such that after electric power needed to the driving is supplied, the light source part 10 outputs the light 100.

The light 100 output from the light source part 10 propagates mainly from the light incidence surface 110 of the laminated body 11 to the inside of the light incidence part 12.

A part of the light 100 propagating the light incidence part 12 propagates while repeating the reflection on the front surface 121 that becomes a substantial interface between the atmosphere and the light incidence part 12, and the rear surface 122 that becomes a substantial interface between the light incidence part 12 and the background part 16. The part of the light 100 propagating while repeating the reflection is output as the light 102 from the weak illumination region 145.

In addition, a part of the light 101 that has reached the periphery of the groove part 15 is reflected by the side surface 151 or the side surface 152 of the groove part 15. A part of the light 101 reflected is output as the light 103 from the strong illumination regions 140 to 143 corresponding to the groove parts 15a to 15d that have reflected the light 101. The light 103 reflected by the groove part 15 so as to be output has the number of light flux per unit area greater than the light 102 reflected by the background part 16 so as to be output.

Consequently, the weak illumination region 145 is weakly illuminated by an indirect illumination. In addition, the strong illumination regions 140 to 143 are strongly illuminated than the weak illumination region 145 although an indirect illumination, and simultaneously the groove part 15 forming the display pattern 14 is three-dimensional, thus a display having a depth feeling and a three dimensional feeling can be provided.

Hereinafter, one example of a manufacturing process of the display device 1 will be explained.

### Manufacturing Process of the Display Device 1

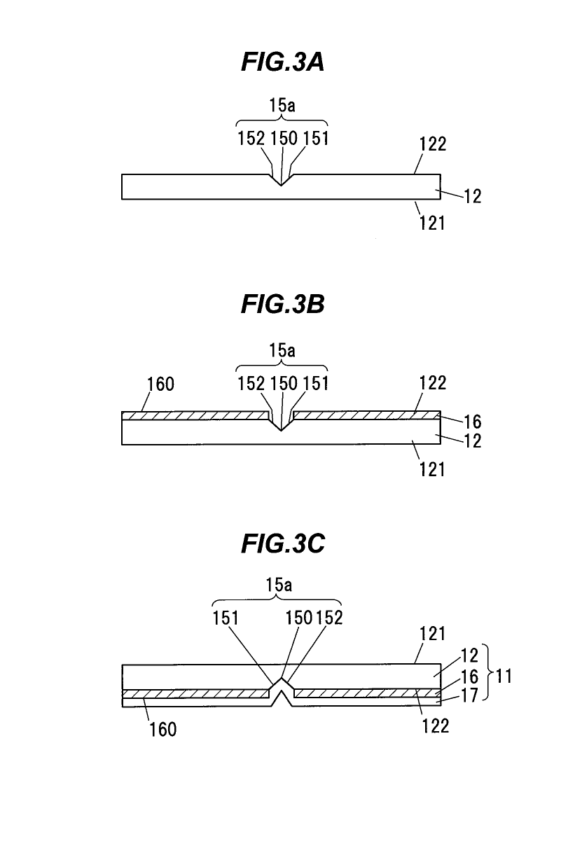

FIGS. 3A to 3C are cross-sectional views schematically showing the primary portion of a manufacturing process of the display device according to the embodiment of the invention. FIGS. 3A to 3C show the manufacturing process of the display device 1 by using a section cut along the line II(b)-II(b) in FIG. 1B as the primary section.

First, as shown in FIG. 3A, by an injection molding, the light incidence part 12 in which the groove parts 15a to 15d are formed is formed.

Next, as shown in FIG. 3B, the background part 16 is formed by printing. The background part 16 is formed so as to avoid the groove parts 15a to 15d.

Next, as shown in FIG. 3C, the reflection part 17 is formed on the rear surface 160 of the background part 16 by printing so as to obtain the laminated body 11, and the laminated body 11 is disposed on the substrate 2 (not shown) so as to obtain the display device 1 (not shown). The reflection part 17 is also formed in the inside of the groove parts 15a to 15d.

### Advantages of the Embodiment

The display device 1 according to the embodiment is capable of allowing a display to have an excellent design with a depth feeling and a three dimensional feeling. In particular, the display device 1 is configured such that the background (the weak illumination region 145) is indirectly illuminated, and simultaneously the display pattern 14 is formed based on the light reflected by the reflection part 17 formed three-dimensionally, thus the display pattern 14 is strongly illuminated than the background although an indirect illumination, so that the display device 1 can provide a display that has an excellent design with a depth feeling and a three dimensional feeling.

The display device 1 is configured such that the groove part 15 is formed in the light incidence part 12, thus a larger quantity of the light can be reflected upward in comparison with the light reflected by the rear surface 122 of the light incidence part 12 in comparison with the light reflected by the rear surface 122 of the light incidence part 12, so that the strong illumination regions 140 to 143, namely display pattern 14 where brightness is higher than that of the weak illumination region 145 can be formed.

The display device 1 is configured such that an angle θ₁ formed between the side surface 151 of the groove part 15 and the rear surface 122 of the light incidence part 12 and an angle θ₂ formed between the side surface 152 and the rear surface 122 are configured to be substantially equal to each other, thus the groove part 15 can be easily formed and production cost can be reduced.

The display device 1 has a simple configuration for providing a display that has an excellent design with a depth feeling and a three dimensional feeling, thus production cost can be reduced in comparison with a device providing a display configured to represent the depth feeling and the like by adjusting an angle and the like of the illumination.

The display device 1 is configured such that the light source part 10 is arranged in the side surface of the laminated body 11, thus an effect of an indirect illumination can be obtained in comparison with a case of illuminating from a position below the display pattern. In addition, the display device 1 is configured such that although the light enters from the side surface, the strong illumination regions 140 to 143 and the weak illumination region 145 can be formed, thus variations are brought to the display so that an excellent design can be provided.

Hereinafter, Modifications 1 to 3 of the groove part of the embodiment will be explained.

### Modifications

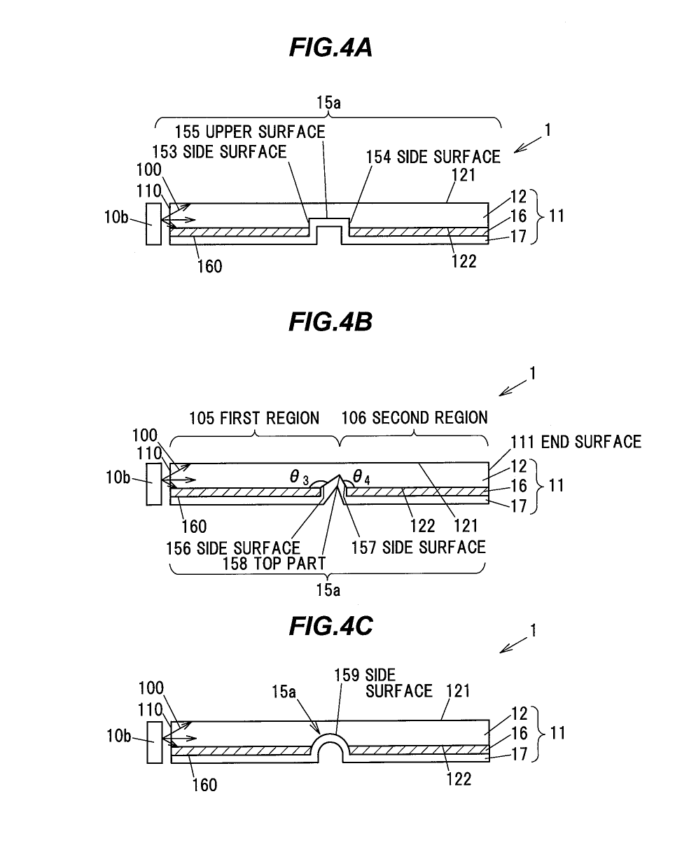

FIGS. 4A to 4C are cross-sectional views schematically showing the primary portion of Modifications 1 to 3 according to the embodiment of the invention. In Modifications 1 to 3 described below, to the same components in configurations and functions as those of the embodiment, the same references as used in the embodiment will be used, and detail explanation will be omitted.

As shown in FIG. 4A, Modification 1 is configured such that the groove part 15 has a concave shape that is formed to have the substantially same width from the top to the bottom instead of the tapered shape. Further, in FIG. 4A, as an example of the groove part 15, the groove part 15a is shown, but the groove parts 15b to 15d have the substantially same shape as the groove part 15a.

In particular, the display device 1 of Modification 1 includes the groove part 15 of a concave shape formed to have the substantially same width. The groove part 15 of Modification 1 is configured such that the side surfaces 153, 154 become approximately perpendicular to the rear surface 122 of the light incidence part 12. In Modification 1, the distance from the upper surface 155 of the groove part 15 to the rear surface 122 of the light incidence part 12 can be formed in the same range as the distance d described in the embodiment, but not limited to this.

In the case of Modification 1, a part of the light propagating the light incidence part 12 is reflected by the side surfaces 153, 154 and the upper surface 155 while being repeatedly reflected. Of the lights reflected, a part of the light reflected by the upper surface 155 is mainly output from the light incidence part 12, so as to form the strong illumination regions 140 to 143, namely the display pattern 14.

As shown in FIG. 4B, Modification 2 is configured such that an angle θ₃ of the side surface 156 of the groove part 15 and an angle θ₄ of the side surface 157 thereof are different from each other. The angle θ₃ is an angle formed between the side surface 156 and the rear surface 122, and the angle θ₄ is an angle formed between the side surface 157 and the rear surface 122.

In particular, the display device 1 of Modification 2 is configured such that the side surface 156 and the side surface 157 that have different angle from each other are formed in the groove part 15 extending in a direction intersecting with an optical axis of the light source part 10, namely the groove parts 15a, 15c. The groove parts 15a, 15c are configured such that the angle θ₃ of the side surface 156 closer to the light source part 10 is formed to be larger than the angle θ₄ of the side surface 157 located on the opposite side. The other groove parts 15b, 15d can be configured such that, for example, the side surfaces have the substantially same angle with each other. Consequently, FIG. 4B shows the groove part 15a, but the groove part 15c has the substantially same angle as that of the groove part 15a.

As shown in FIG. 4B, it is considered that the first region 105 from the light incidence surface 110 of the light incidence part 12 to the side surface 156, for example, depending on the arrangement of the groove part 15, includes a larger quantity of incident light than the second region 106 from the end surface 111 of the light incidence part 12 located on the opposite side to the side surface 157. In other words, it is considered that the light propagating through the inside of the light incidence part 12 is blocked by the groove parts 15a, 15c, thus it is difficult for the light to propagate to the second region 106.

Consequently, in order to prevent illumination unevenness between the first region 105 and the second region 106, it is preferable that the angle θ₃ is larger than the angle θ₄. In addition, the distance from the bottom 158 of the groove part 15 to the rear surface 122 of the light incidence part 12 can be formed, as one example, in the same range as the distance d described in the embodiment.

As shown in FIG. 4C, Modification 3 is configured such that the groove part 15 is formed to be a groove of a semicircular shape. The distance from the bottom of the side 159 of the groove part 15 in Modification 3 to the rear surface 122 of the light incidence part 12 is formed in the range similar to the distance d described in the embodiment. A part of the light reflected by the side part 159 is output from the light incidence part 12 so that the strong illumination regions 140 to 143, i.e. the display pattern 14, is formed.

Further, as the other Modification, the display device 1 may be configured such that a reflection member for reflecting a light is formed in the side surface other than the light incidence surface 110. This display device 1 is configured such that the light that has reached the side surface other than the light incidence surface 110 is reflected so that the background and the display pattern 14 can be prevented from the illumination unevenness. In addition, the display device 1 may be configured such that the concave part in the rear side of the groove part 15 is filled with a resin so as to increase electrostatic capacitance detection sensitivity.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth. In particular, it should be noted that all of the combinations of features as described in the embodiment and Examples are not always needed to solve the problem of the invention. Furthermore, the embodiments and modifications thereof can be included within the scope and gist of the invention and within the invention as recited in the attached claims and the equivalents thereof.

What is claimed is:

1. A display device, comprising:
a light source part configured to output a light;
a light incidence part into which the light outputted from the light source part is inputted;
a groove part formed in a first surface of the light incidence part based on a display pattern to be displayed via the light incidence part;
a background part formed on the first surface of the light incidence part except the groove part and configured to form a background of the display pattern; and
a reflection part formed on the groove part and configured to reflect a part of the light that enters the light incidence part so as to form the display pattern on the background formed by a part of the light reflected by the background part,
wherein the inputted light is outputted outside through a second surface opposite to the first surface of the light incidence part.

2. The display device according to claim 1, wherein a part of the light reflected by the background part outputs from the light incidence part, thereby a weak illumination region is formed, in which a weak illumination is carried out, and a part of the light reflected by the reflection part formed in the groove part outputs from the light incidence part, thereby a strong illumination region is formed, in which a stronger illumination than that in the weak illumination region is carried out.

3. The display device according to claim 1, wherein the light source part outputs the light from the side surface of the light incidence part to the inside of the light incidence part.

4. The display device according to claim 1, wherein a distance d between the first surface of the light incidence part and a bottom of the groove part is more than 10% and less than 50% of a thickness of the light incidence part.

5. The display device according to claim 1, wherein a distance d between the first surface of the light incidence part and a bottom of the groove part is not less 20% and not more than 40% of a thickness of the light incidence part.

6. The display device according to claim 1, wherein the light incidence part comprises a light diffusing material to diffuse the inputted light.

7. The display device according to claim 1, wherein the light incidence part comprises a surface texturing on the second surface.

8. The display device according to claim 1, further comprising a touch sensor part disposed parallel to the light incidence part.

9. The display device according to claim 8, wherein the reflection part on the groove part comprises a concave part with a resin filled therein.

10. The display device according to claim 1, further comprising a light reflection member disposed on a side of the light incidence part.
